(19) United States
(12) Patent Application Publication
(10) Pub. No.: US 2017/0300970 A1
(43) Pub. Date: Oct. 19, 2017

(54) SYSTEMS AND METHODS FOR TRACKING MOBILE POINTS OF INTEREST

(71) Applicant: Th3rdShift, LLC, Crystal, MN (US)

(72) Inventors: Matthew Yoder, Crystal, MN (US); Eric Dorphy, Maple Grove, MN (US); Tony Riley, Minneapolis, MN (US)

(21) Appl. No.: 15/488,845

(22) Filed: Apr. 17, 2017

Related U.S. Application Data
(60) Provisional application No. 62/323,715, filed on Apr. 17, 2016.

(51) Int. Cl. G06Q 30/02; H04W 4/20; H04W 4/00

(52) U.S. Cl. CPC G06Q 30/0259; H04W 4/008; H04W 4/206

(57) ABSTRACT

A system for tracking mobile points of interest within a region can include beacons affixed to mobile points of interest, mobile computing devices, and an Internet-connected server. Each of the beacons can broadcast advertisements with unique identifying information via a short-range communication protocol. Each computing device can include beacon communication hardware, Internet communication hardware, and geolocation capability. Each computing device can record advertisements from beacons along with corresponding geolocation information. The computing devices can filter the recorded received advertisements along with corresponding geolocation information, to result in device-filtered beacon location data. The mobile computing devices can transmit the device-filtered beacon location data to the server, which can receive and record the device-filtered beacon location data from the computing devices. The server can filter the device-filtered beacon location data, to result in server-filtered beacon location data. The server can transmit the server-filtered beacon location data to at least one other entity.

### CROSS-REFERENCE TO RELATED APPLICATION

This application claims the benefit of U.S. Provisional Application No. 62/323,715 filed Apr. 17, 2016 and titled SYSTEM FOR COMMUNICATING POSITIONS OF MOBILE POINTS OF INTEREST WITHIN A GEOGRAPHICAL REGION, which is hereby incorporated by reference.

### FIELD OF THE INVENTION

This disclosure relates to systems and methods for determining and reporting locations. More particularly, it relates to systems and methods for determining and reporting locations of mobile points of interest.

### BACKGROUND OF THE INVENTION

For entertainment, recreation, and fitness, people often attend many types of events, such as professional and/or recreational sporting events, festivals, fairs, and the like. For certain events, it is often difficult to know where certain people, vendors, or other points of interest are located, especially when the points of interest, such as participants in races, are mobile. Some events provide spectators with static maps, but the mobility of people and other points of interest limit the usefulness of such maps. Some race events provide websites that provide limited information about the whereabouts of participants, but generally these update only after an athlete has crossed a particular location. This means spectators are only informed of an athlete's location after the fact, which can lead to spectator frustration, spectators getting lost at the event, and a decrease in event satisfaction. In the case of race events, spectators may miss their favorite racer on the course. In a professional sporting event, the inability for spectators to find a particular concession vendor may lead to lost revenue. Therefore, it would be desirable to provide systems and methods that can track mobile points of interest during events and alert interested parties in near real-time where the mobile point of interest, such as race participants and/or concession vendors, are located.

### SUMMARY OF THE INVENTION

The disclosed system can be used to track mobile points of interest during events and to alert attendees in near real time where mobile points of interest are located. The system can include one or more beacons, such as Bluetooth Low Energy beacons, that can be affixed to or worn by mobile points of interest; one or more spectators with one or more compatible mobile devices (e.g., smartphones or tablets); and one or more network connected servers, which can be cloud-hosted.

The disclosed system can collect data via mobile devices from wireless beacons located on a plurality of mobile points of interest and transmit collected data to a server database. The system can use this data to generate a dynamic map of the geographic region that includes mobile points of interests. It can present the dynamic map to individuals, such as spectators, with a compatible mobile device or any suitable Internet connected system who are connected to the server. The dynamic map can allow event spectators to know the location of mobile points of interest in near real time. Near real time mapping can help spectators to easily find things that they are interested in or are looking for, which can reduce frustration and potentially increase revenue for event vendors (who can be mobile points of interest).

The disclosed system can use algorithms to filter reported data so that the higher quality and more reliable data is stored by the system and reported to users. This filtering can be desirable because the beacons transmit data at a high rate that can result in potentially redundant data. Filtering data at the mobile device can prevent uploading redundant data to the server and thus can prevent server overload and unnecessary cellular data use. Filtering data at the server can prevent storing and reporting redundant data to the users. In a non-limiting example the mobile device that collects the data can filter the data on one or more criteria that can include accuracy of the geolocation information and accuracy of the beacon radio frequency signal. Likewise, the server can filter on the same or similar criteria before storing and reporting the data.

In one non-limiting example, distance running event athletes can wear a wireless beacon, and spectators can be presented with a map that updates to show the real-time location of athletes they follow. This can allow spectators to locate the athlete they are following on the course so that they can plan where to view the race.

In another non-limiting example, a temporary event, such as a state fair, can have wireless beacons placed at vending locations or at amusement rides to allow visitors to know where vendors are located.

In yet another non-limiting example the present disclosure provides a system for tracking mobile points of interest within a geographical region. The system can include one or more beacons affixed to one or more corresponding mobile points of interest, one or more mobile computing devices, and an Internet-connected server. Each of the one or more beacons can be structured and configured to broadcast advertisements with unique identifying information via a short-range communication protocol. Each mobile computing device can include beacon communication hardware configured to receive advertisements broadcast by the one or more beacons, Internet communication hardware, and geolocation capability. Each mobile computing device can be programmed and configured to record received advertisements from the one or more beacons along with corresponding geolocation information from the geolocation capability. For each of the one or more beacons from which the mobile computing device has recorded received advertisements, it can be programmed and configured to filter the recorded received advertisements along with corresponding geolocation information, to result in device-filtered beacon location data. The mobile computing device can be programmed and configured to transmit the device-filtered beacon location data via the Internet communication hardware. The Internet-connected server can be programmed and configured to receive and record the device-filtered beacon location data from each of the one or more mobile computing devices for each of the one or more beacons from which the one or more mobile computing devices have recorded received advertisements. For each of the one or more beacons from which the one or more mobile computing devices have recorded received advertisements, the server can be programmed and configured to filter the device-filtered beacon location data, to result in server-filtered beacon location data. The server can be programmed and configured to transmit the server-filtered beacon location data to at least one other entity.

The above summary is not intended to describe each and every example or every implementation of the disclosure. The Description that follows more particularly exemplifies various illustrative embodiments.

### BRIEF DESCRIPTION OF THE DRAWINGS

The following description should be read with reference to the drawings. The drawings, which are not necessarily to scale, depict examples and are not intended to limit the scope of the disclosure. The disclosure may be more completely understood in consideration of the following description with respect to various examples in connection with the accompanying drawings, in which:

FIG. 1 is a schematic diagram illustrating aspects of the systems and methods of the tracking system of the present disclosure;

FIG. 2 is a multi-lane flow diagram that illustrates aspects of an exemplary beacon tracking system of the present disclosure relating to beacon detection functions;

FIG. 3 is a flow diagram of a method for processing or filtering beacon advertisement information that can be executed on a mobile device;

FIG. 4 is a flow diagram of a method for handling beacon data pertaining to a beacon ID that is uploaded to a server;

FIG. 5 is a flow diagram of a method for processing or filtering beacon location data at the server;

FIG. 6 is a flow diagram that illustrates aspects of the beacon tracking system of the present disclosure particularly relating to reporting of beacon location information;

FIG. 7 is a schematic diagram illustrating an example user interface displaying the location of beacons;

FIG. 8 is a schematic block diagram depicting an example radio frequency transmitter used in accordance with embodiments of the present disclosure; and

FIG. 9 is a schematic block diagram depicting an example computing system used in accordance with embodiments of the present disclosure.

### DETAILED DESCRIPTION

The present disclosure relates to systems and methods for determining and reporting locations of mobile points of interest. Various embodiments of the systems and methods are described in detail with reference to the drawings, in which like reference numerals may be used to represent like parts and assemblies throughout the several views. Reference to various embodiments does not limit the scope of the systems and methods disclosed herein. Examples of construction, dimensions, and materials may be illustrated for the various elements, those skilled in the art will recognize that many of the examples provided have suitable alternatives that may be utilized. Any examples set forth in this specification are not intended to be limiting and merely set forth some of the many possible embodiments for the systems and methods. It is understood that various omissions and substitutions of equivalents are contemplated as circumstances may suggest or render expedient, but these are intended to cover applications or embodiments without departing from the spirit or scope of the disclosure. Also, it is to be understood that the phraseology and terminology used herein are for the purpose of description and should not be regarded as limiting.

### OVERVIEW

In some embodiments, the disclosed systems and methods can include, without limitation, beacons configured to attach to, and be associated with, one or more mobile points of interest, such as event participants and/or concession vendors; computing devices (some or all of which can also be mobile) that can detect the beacons and host an application to process beacon data; and a server-based system that can receive information about detections of beacons from the computing devices and provide information about beacon whereabouts to interested parties in near real-time. It is to be understood that the term “mobile points of interest” can be, but is not limited to, a person or thing that is currently moving (e.g. a person in a race, etc.), a person or thing that is intermittently moving (e.g. a food vendor, emergency medical personal, etc.) or a person or thing whose current position is fixed for a temporary period of time (e.g. a race start or finish line, medical tent, etc.).

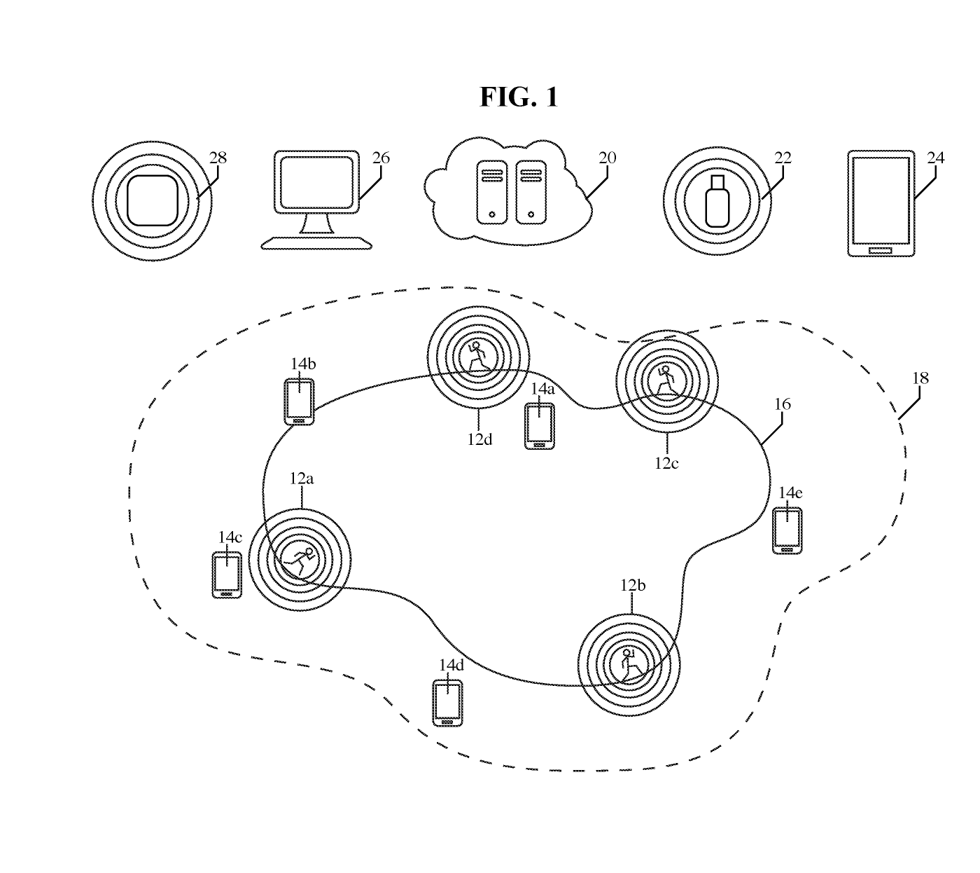

FIG. 1 is a schematic diagram illustrating aspects of the systems and methods of the tracking system of the present disclosure. In the illustrated example of FIG. 1, the tracking system can be used to provide information about the whereabouts of mobile points-of-interest that are runners at 12a, 12b, 12c, and 12d (as well as possibly other runners not illustrated) participating in a race around a course 16, but this is just an example and the disclosed tracking system could be employed in other scenarios. For example, the disclosed system could be used at an amusement park, and mobile points-of-interest could be any of mobile concession vendors, park visitors, roaming princess characters, and so on.

Each runner 12a-12d in the example of FIG. 1 can have an associated beacon 12a-12d, as denoted by the symbol of concentric circles surrounding each runner. In this example, reference numerals 12a-12d refer interchangeably to the runners/mobile points-of interests and the beacons associated therewith, but those of skill in the art will readily recognize that it is the beacons that can be detected by the system—accordingly, information about the location of mobile points-of-interest can depend on beacons remaining in close proximity to their associated mobile points-of-interest. This proximity can be maintained by beacons being worn or otherwise attached to mobile points-of-interest, as described further herein.

Computing devices 14a, 14b, 14c, 14d, and 14e (as well as possibly other computing devices not illustrated) can be located at various places in the vicinity (or not necessarily in the vicinity) of the course 16. As discussed further herein, computing devices 14a-14e can include hardware capable of detecting beacons 12a-12d (as well as possibly other beacons), subject to proximity of the beacons to the computing devices. Communication protocols by which computing devices 14a-14e detect beacons 12a-12d can be relatively short range protocols, such as Bluetooth. Computing devices 14a-14e can communicate information pertaining to beacon detections to a server system 20 via an information network such as (but not limited to) the Internet. Prior to communicating beacon detection information to server system 20, computing devices 14a-14e can be programmed and configured to filter the information, which can improve the quality of data transmitted to the server system and reduce bandwidth requirements.

In some embodiments, beacons generally do not have built-in geolocation capability, but computing devices generally do have geolocation (such as via GPS and/or GLONASS, etc.) built-in, or if stationary, are at known geographic coordinates. When communication modes by which computing devices 14a-14e detect beacons 12a-12d are relatively short range, the location of a computing device when it detects a beacon can be a good proxy or surrogate for the location of the beacon.

Server system 20 can receive beacon detection information from computing devices 14a-14e (as well as possibly other computing devices) and can perform filtering on such data, which can result in improved beacon location data. Server system 20 can share beacon location data with interested parties via entities such as computing devices 14a-14e, as well as via other information platforms 22, 24, 26 and 28, where communication between the server system and computing devices and information platforms can be facilitated by an information network such as (but not limited to) the Internet. The interested parties could be, for example and without limitation, spectators or support personnel at the event, friends or fans of runners 12a-12d following their progress at a distance, event administrators, or any other suitable parties. Information systems 22, 24, 26 and 28 can include, but are not limited to, personal computing systems, network connected televisions, computing systems that connect a television to a network, tablet devices and other systems capable of communicating with the server system.

### Beacons

In embodiments of present disclosure, a beacon such as beacons 12a-12d can be a Bluetooth device, and more specifically can be a Bluetooth 4 (or higher version, e.g. Bluetooth 4.1, 4.2, 5, etc.), Bluetooth Smart, and/or Bluetooth Low Energy (BLE) device (and/or another or future Bluetooth protocol device) that can be configured to periodically emit a Bluetooth format radio frequency signal. However, this is not limiting, and in other embodiments, a beacon, can be any suitable device that can transmit uniquely identifying information that can be detected by computing devices (described further elsewhere herein) configured to detect beacons. In some embodiments, the communication protocol (such as Bluetooth Low Energy) by which beacons communicate with computing devices are effective only over relatively short ranges such as less than about 100, 80, 60, or 40 meters. Using a short-range communication protocol can help ensure that the position of a beacon detected by a computing device is similar to the position of the computing device, within the maximum range of the communication protocol.

Many Bluetooth devices can have characteristics that can make them particularly suitable for use as beacons, including low weight, low volume, low cost, low power consumption, and widely adopted use of the Bluetooth radio frequency protocol. (Other non-Bluetooth beacon devices may also exhibit some or all of these characteristics.) In non-limiting examples a beacon can be configured to be worn or otherwise attached to a user (mobile point-of-interest), such as with a clip, loop, or lanyard, etc., or a beacon could be placed in a pocket, etc. A beacon can be affixed to event equipment, such as a race bib, or a clothing item or accessory, such as a wrist worn band, toe tag, shoelace, or other accessory. A Bluetooth beacon can weigh on the order of 10-20 grams, and can displace a volume on the order of single digits of cubic centimeters. Such a small, light device may be essentially unnoticed by users/wearers/mobile points-of-interest, which may be important for acceptance by users. Low power consumption can enable a beacon to operate for the entire duration of an event, or for enough time for multiple events, on a single battery, such as a type 2032 lithium battery, or any other suitable battery or energy storage device. In some embodiments, a beacon could include an energy-harvesting mechanism and not require an energy storage device to provide operational power.

In another embodiment, the beacon could be capable of transmitting information via other radio frequency protocols (e.g. Zigbee, Wi-Fi, NFC, etc.) and methods (e.g amplitude modulation, frequency modulation, etc.), light signals, acoustic signals or mechanical signals (e.g. vibration).

### Beacon ID

In embodiments of present disclosure, beacons can be configured to broadcast unique identifying information, for example in Bluetooth format data packets. In some embodiments, a beacon can be programmed to transmit one or more unique identifiers. In some embodiments, beacons can be coded at manufacture with a unique identity. In some other embodiments, beacons can be programmed after manufacture with an identity, which can be a unique identity, by any appropriate organization, authority, or entity. In some examples, such programming can be done via Bluetooth, via direct electrical connection or via another method. In some implementations, unique identifying information broadcast by beacons can be arbitrary, without intrinsic meaning. In such cases where the unique identifying information is arbitrary, any association or correlation with a particular mobile point-of-interest (such as the identity of a race participant) can be done externally, for example, at the server level. In some other implementations, unique identifying information could include non-arbitrary information, such as personally-identifiable information. In some embodiments, non-arbitrary information such as person's name, name of an organization, website address, and so on, can be broadcast.

In the present disclosure, “beacon ID” can describe unique identifying information associated with a beacon that the beacon broadcasts.

### Beacon Data

In some embodiments, beacons can broadcast only unique identifying information (whether arbitrary or not) that does not change from broadcast to broadcast. In other embodiments, beacons could broadcast any suitable dynamic information, such as (but not limited to) temperature, altitude, activity level (e.g., through accelerometers), and biometrics (such as heart rate). In some examples, a beacon could have geolocation capability built-in, such as a GPS and/or GLONASS receiver/processor, and the beacon could broadcast location information. However, it is envisioned that in many or most embodiments and implementations of systems of the present disclosure, most or all beacons do not have built-in geolocation capability, and that beacon location determination is performed elsewhere in the systems and methods, such as in computing devices that detect beacons, and in server-level systems that process beacon location data, as discussed further herein. Beacons not including geolocation capabilities can be less expensive, lighter, smaller, and less power-consuming than self-geolocating beacons.

In the present disclosure, “beacon data” can describe data transmitted by the beacon other than a beacon ID or data associated with a beacon ID (such as “beacon location data”) which can describe geolocation data associated with the beacon. The beacon location data can be directly transmitted by the beacon to the recipient application or can be measured by the application and associated with the beacon data. In turn, the beacon data can be associated with the beacon ID to associate the data with a unique beacon.

In some embodiments both a beacon ID and beacon data can be transmitted at the same time by the beacon so that other agents of the system can associated the beacon ID, transmitted data and location of the beacon together.

### Beacon Discovery

In some embodiments, beacons can broadcast information with essentially a fixed frequency (for example, once every 100 milliseconds). In some other embodiments, beacons could be configured to transmit at varying frequencies, for example, tied to activity level in a beacon incorporating an activity-level sensing mechanism. In some embodiments, a beacon could be configured to transmit information after detecting a specific signal, such as a triggering signal from a computing device configured to detect beacons or a signal from another beacon. It is envisioned that in many embodiments and implementations of systems of the present disclosure, beacons can transmit information autonomously, without any external trigger, input, or stimulus. Transmissions from beacons can be referred to as “advertisements.”

Systems and methods of the present disclosure can be practiced with beacons operating in accordance with any suitable beacon operating and/or communication protocols, including Apple's iBeacon profile, Google's Eddystone format, or other proprietary or non-proprietary beacon protocols.

A “discovery” or “discovery event” of a beacon can refer to the act or actions of a computing device with an associated application that is programmed to detect the signal from the beacon detecting the desired signal.

Beacons can be distributed to and associated with mobile points-of-interest (such as event participants like runners) by any suitable methods. For example, in the case of a running race, beacons can be distributed to race participants as part of race registration and can attach to apparel or other equipment that the race participants will wear during the race. A beacon can associate a race identity (i.e., a bib number, beacon number, etc.) with a race participant. This association could be programmed by the race organization, or the race participant could be issued an unassociated beacon and the participant could make the association themselves, for example, via a website or application running on a computing device such as a smartphone or tablet. In another example, race participants can use a specific beacon at a plurality of events and, instead of associating the race participants with a race identity for a specific race, a beacon can associate the race participant with a persistent identification.

In some embodiments, the beacons can be programmed to communicate with one another as well as transmitting data to a system programmed to detect the beacons. In this type of network the beacons can both send and receive data. In this type of embodiment, the beacons would be able to receive data from other systems that are around them giving the beacons information about their local environment. A non-limiting example of this would be a beacon affixed to a race participant that was programmed to receive data from waypoints along the course or from other racers (e.g. the participant was running with others that they were friends with).

Beacon Detection Via Computing Devices with Mobile Application

In embodiments of present disclosure, computing devices such as computing devices 14a-14e of FIG. 1 can be programmed and configured to detect beacons, process beacon data, and transmit beacon data to a server system such as system 20. As a separate but related type of functionality, computing devices can be programmed and configured to receive information about beacon locations from the system server and display or otherwise convey such information to users about beacon locations. In the present disclosure, a computing system can provide the first set of functionality (beacon detection, information processing, and information transmitting, hereinafter referred-to collectively, but without limitation, as “beacon detection functions”), but not the second set of functionality (receiving and conveying beacon location data, hereinafter referred-to collectively, but without limitation, as “beacon location reporting”), and vice-versa, that is, provide “beacon location reporting” without providing “beacon detection functions.”

However, it is envisioned that systems and methods of the present disclosure will often include computing systems that provide both sets of functionality (“beacon detection functions” as well as “beacon location reporting”), and indeed, there can be significant advantages to having computing systems providing both kinds of functionality. Consider the example of a running race, as illustrated in FIG. 1. As discussed further elsewhere herein, the quality and quantity of beacon location data derived from beacon detections by computing devices such as devices 14a-14e can improve significantly with greater numbers and wider distribution of such computing devices. Some of these computing devices that can provide “beacon detection functions,” and in some cases, a vast majority of such devices, can be mobile computing devices (hereinafter “mobile devices”) such as smartphones or tablet computers possessed by spectators and other persons associated with the event. In order to encourage persons to install application software on to their mobile devices that will program and configure their devices to provide “beacon detection functions” functions, the application software can also include functions desirable to the persons, such as “beacon location reporting,” which they can use to follow the location of participants in the race. In some implementations, it is possible that other enticements could be provided to encourage installation of application software on mobile devices to provide “beacon detection functions,” and thus grow the network of beacon detection-capable mobile devices. In some cases, event organizers, sponsors, etc., can include “beacon detection functions” in application software having broader functionality and/or appeal—for example, “The Official App of the Springfield Marathon,” or “The Official App of the Washington County Fair.”

While it is envisioned that mobile devices may commonly be used for “beacon detection functions”, systems and methods of the present disclosure are not limited to using only mobile devices, and any suitable computing devices may be used. In some cases, computers such as desktop or laptop computers could be used for “beacon detection functions” at generally fixed locations. In some examples, mobile devices could be used at essentially fixed locations; while such devices could be moved from place-to-place during an event, in these examples they could be kept stationary. Computing device at fixed locations could be deployed by event organizers to provide “beacon detection functions” at locations where spectator densities are anticipated to be low. In the present disclosure, “mobile” should not be considered to be limiting, and any particular device or entity should only be considered to be strictly mobile or strictly stationary if explicitly described as such.

Additionally, it is envisioned in the present disclosure that not all users of devices 14a-14e need to be within the geographic area or region 18 (FIG. 1) of the event to use the system. A non-limiting example of this are spectators of a running race who are tracking a friend or family member. Users of devices 14a-14e can provide the “beacon detection function” and the users of systems 22, 24, 26 and or 28 can use their systems for the “beacon location reporting” function.

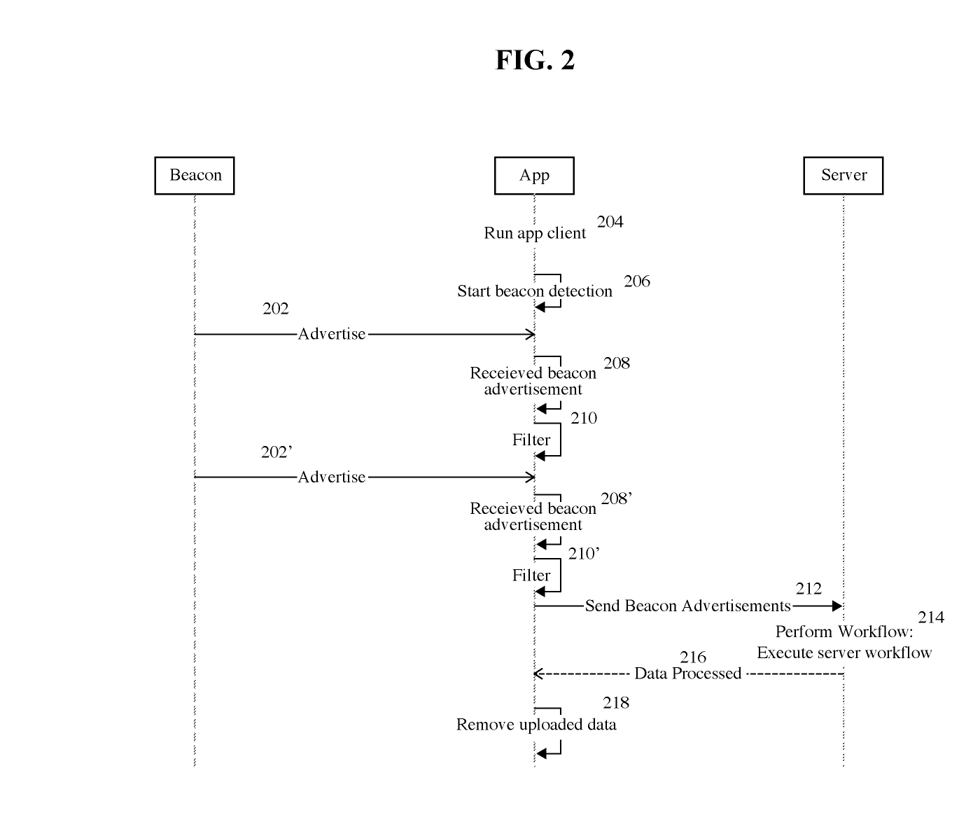

FIG. 2 is a multi-lane flow diagram that illustrates aspects of an exemplary beacon tracking system of the present disclosure, with particular focus on “beacon detection functions” aspects of operation of a mobile device and an application (“App”) executing on the mobile device in embodiments of the present disclosure. While a particular sequence of operations may be described, suggested, or implied by FIG. 2, such a sequence should not be considered limiting and any suitable sequence of operations is possible unless otherwise explicitly stated. The left-most lane of the flow diagram represents a beacon, which transmits advertisements at 202, 202′, etc. In some examples, beacons do not transmit advertisements until actuated or otherwise turned on by, for example, a human mobile-point of interest such as a runner in a race.

The middle lane of the flow diagram of FIG. 2 represents an App executing on a mobile device. At 204, the App can receive any suitable parameters via a user interface of the mobile device. To use the App, the user may be required to register as a user of the server-based beacon tracking system, and enter their user ID at 204. Other information/parameters that a user may enter at 204 can include the identities of mobile-points-of-interest whose locations are of interest to the user, such as friends participating in a race, and identifying information about specific events of interest to the user, such as races, fairs, festivals, and the like. User information at 204 can include whether the user agrees to permit their device to detect beacons (in general, and/or for specific events), process beacon data, and transmit beacon detection data to the server system that hosts the beacon tracking system. In some embodiments, parameters can be entered via a user interface other than that of the App, such via the user interface of a web site hosted by the server system, with such parameters being associated with a user ID and available to the App when the App is associated with the same user ID.

In the present discussion of operation of the App of FIG. 2, various actions may be described as being executed or performed by the App. Generally, such actions may involve the server system as well as the App, but the server system need not necessarily be involved in every such action so described, unless explicitly stated for a particular action. Involvement of the server system can include (but is not limited to) exchange of information between the server system and the App, and execution of code or algorithms in support of App functions.

At 206, the App can determine which events (i.e., races) are associated with the spectator, and can determine which beacons to detect, which can be beacons associated with events associated with the spectator. These determinations can involve information received at 204. At 206, the App can compile, collect, receive, or otherwise define a list of beacons to (potentially) perform “beacon detection functions” for. In some examples, such a list of beacons can be provided to the App from the server system. The list of beacons can include, for example, the unique identifying beacon ID for each beacon of interest.

At 206, the App and server system can determine whether to scan for beacons, based upon criteria that can include (but are not necessarily limited to): whether the user agrees to permit their device to detect beacons (in general, and/or for specific events), whether the mobile device is within the vicinity of an event of interest, both geographically and with regard to the time of the event's occurrence, and whether the mobile device has sufficient resources such as energy and communicative connectivity. With regard to vicinity, “geofencing” can be used to define a region, such as region 18 around course 16, schematically indicated by a dashed border in FIG. 1. As illustrated, mobile device 24 of FIG. 1 is outside region 18, while mobile devices 14a-14e are within region 18, so if, in an example, region 18 was used to define a region for an event, mobile device 24 generally would be excluded from “beacon detection functions” for the event as being outside of the event's region, while devices 14a-14e generally would not be excluded on the basis of location relative to the event. Similarly, “time-fencing” could be used to define time boundaries around an event, so that at times sufficiently outside the defined event times, devices could be excluded from scanning for beacons related to the event. Borders for geofencing and time boundaries for time-fencing can be established in any suitable manner, including automated, manual, and hybrid auto/manual methods. In some examples, a boundary for a geofence may be established at a default or a custom radius from an event location. In some examples, a boundary for a geofence may be defined with a shape more complex than a simple radius around a point.

If the App determines at 206 to scan for beacons, beacon detection can initiate. At 208, 208′, etc., the mobile device running the App can receive and record information contained in advertisements transmitted by the beacon at 202, 202′, etc. In addition to recording the information of the beacon advertisement, the mobile device App can also record any other suitable information, including (without limitation) the time of the beacon discovery, the distance of the beacon from the mobile device making the beacon discovery, and the geolocation of the mobile device at the time of the beacon discovery. Any or all of these pieces of information can be included in “beacon data” associated with a beacon discovery. As discussed further elsewhere herein, the geolocation of the mobile device can be a proxy or surrogate for the location of the beacon.

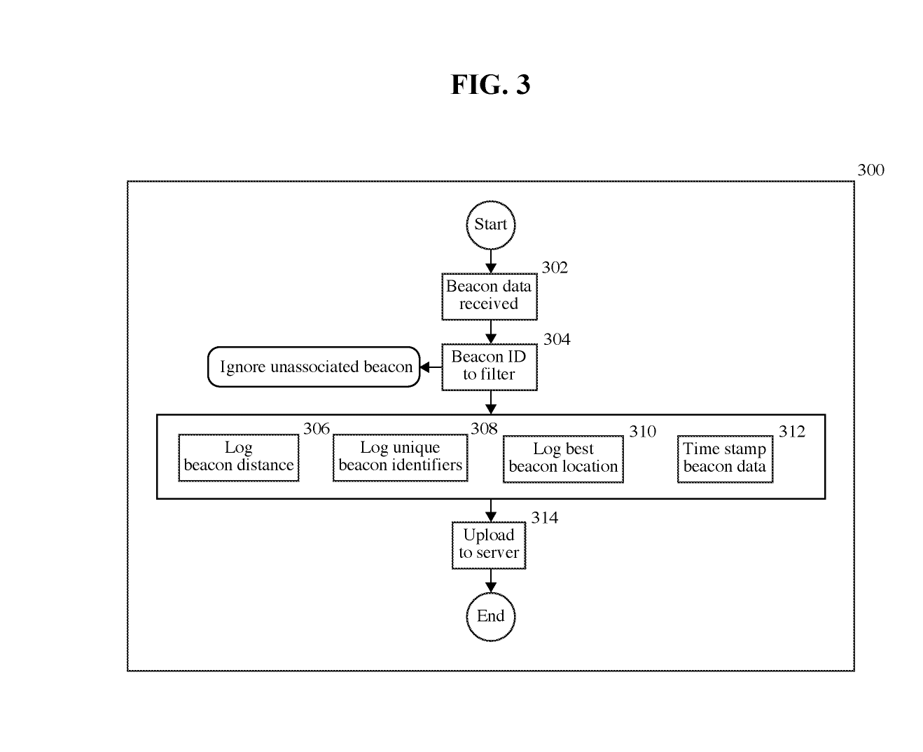

After recording advertisement information at 208, 208′, etc., the App can perform information processing or “filtering” on said data at 210, 210′, etc. Information processing/filtering is discussed in further detail elsewhere herein, including in relation to FIG. 3. While the flow diagram may suggest that beacon advertisement data processing/filtering 210, 210′, etc. is performed immediately after each individual beacon discovery 202, 202′, etc. this is not necessary in all cases. In some embodiments, information from multiple beacon discoveries 202, 202′, etc. can be stored without immediately subsequent processing, then processing/filtering 210, 210′, etc. performed in a batch on information from multiple beacon advertisements. In the schematic flow diagram of FIG. 2, advertisements from a single beacon are represented at being transmitted at 202, 202′, etc. and received at 208, 208′, etc. In parallel, other beacons can transmit advertisements, and the mobile device running the App can receive and record and filter such information.

At 212, beacon data, which can be data pertaining to one or more received beacon advertisements, can be transmitted by the mobile device App to the server system by any suitable communication protocol, such as a cellular data protocol, Wi-Fi, etc. In some embodiments, beacon data can be transmitted essentially as soon as possible after each beacon discovery 208, 208′. In some embodiments, beacon data can be stored by the App and transmitted to the server in batches. Beacon data transmitted at 212 can be filtered, as discussed elsewhere herein. In some embodiments, unfiltered beacon data (meaning information from essentially all received beacon advertisements) can be transmitted to the server, but this can be substantially more information than filtered data, and hence, transmitting filtered beacon data can conserve resources such as bandwidth and mobile device energy needed to transmit data. Beacon data transmitted at 212 can be filtered beacon data from multiple beacons. After received beacon data is transmitted to the server at 212, the server can communicate confirmation to the App that it has received the data at 216, after which the App can delete, erase, or otherwise clear the transmitted beacon data from its memory at 218.

The right lane of the flow diagram of FIG. 2 represents a server system of the beacon tracking system of the present disclosure. After receiving beacon data from the mobile device App at 212, the server can filter the beacon data at 214, as discussed further elsewhere herein, including in relation to FIG. 3.

Returning to the operation of the App executing on the mobile device, as mentioned herein, beacon data recorded at beacon discovery 208, 208′, etc. can be processed or filtered at 210, 210′, etc. Generally, filtering of the beacon data and/or beacon location data by the computing device can reduce the amount of beacon data stored by the computing device and improve the quality of beacon data after filtering, in terms of the accuracy of location information or quality of the data transmitted by the beacon. FIG. 3 is a flow diagram of a method 300 for processing or filtering beacon data that can be executed by the App, which can be the processing or filtering 210, 210′, etc. of FIG. 2. Method 300 can be a set of operations for filtering beacon data from a single beacon discovery 208, 208′, etc., with method 300 being executed for each beacon discovery. While a particular sequence of operations may be described, suggested, or implied by FIG. 3, such a sequence should not be considered limiting and any suitable sequence of operations is possible unless otherwise explicitly stated.

At 302, a new or next set of beacon data (where each “set of beacon data” corresponds to a single beacon discovery 208, 208′, etc.) can be entered, loaded, or otherwise considered. If beacon data is being filtered directly after each individual beacon discovery 208, 208′, etc., method 300 can commence with operation 302 essentially immediately after each beacon discovery. In cases in which beacon data from multiple beacon sightings 208, 208′, etc. are batched processed, operation 302 can occur for each set of beacon data in turn as the batch is being processed.

At 304, a determination can be made whether the set of beacon data is of interest. This determination can be made according to any suitable criteria, including whether the beacon ID is included on a list of beacon IDs of interest, which can be a list loaded or otherwise compiled at operation 206 of FIG. 2.

At 306, the method can include assessing whether the set of beacon data includes a beacon distance between the mobile device and the beacon. The beacon distance can be determined by any suitable means. In some examples, the beacon distance can be calculated based upon received signal strength indicator (RSSI). Such a calculation can be included as a standard function or algorithm in a beacon library or protocol. In some examples, beacon distance calculations can consider other factors such as information from multiple beacon advertisement receiving/recording events, and/or the elapsed time since a beacon discovery has occurred. If the beacon distance is not known, the beacon data can be ignored and the method can return to 302.

At 308, the processing can include assessing whether the beacon discovery represents a duplicate beacon discovery, meaning a discovery of a beacon that has been discovered by the mobile device previously, or whether it is for a new beacon discovery. Beacon discoveries can be considered new or old based on a number of factors, including but not limited to, whether or not the beacon has been discovered previously within a certain time period or whether or not the beacon has ever been discovered by the user at a particular geographic location. If it is a new beacon discovery, method 300 can include at 310 assessing the quality of geolocation information (colloquially described as “GPS data,” but this is not limiting) associated with the beacon discovery, according to any suitable criteria. If the geolocation information quality is deemed to be inadequate (for example, if an uncertainty in location exceeds a predetermined distance), then the beacon data can be ignored and the method can return to 302. If, alternatively, the geolocation information is deemed to be of sufficient quality, then the method can proceed to 312.

If the beacon discovery represents a duplicate beacon discovery, then at 310 the method 300 can assess whether the geolocation information associated with the currently-considered beacon discovery is inferior to other available geolocation information, which can be geolocation information for another discovery of the same beacon, or in some cases could be geolocation information acquired by the mobile device relatively recently (according to any suitable criteria). If the other geolocation information is superior, then it can be associated with the present beacon discovery at 310 in lieu of the originally-associated geolocation information. Geolocation information quality can be assessed with any suitable criteria. One criterion can be uncertainty of the geolocation, with lower uncertainty meaning higher quality. Geolocation uncertainty can be calculated by a standard function or algorithm associated with geolocation capabilities of the mobile computing device. In the case of a computing device used at a fixed location (at least for the duration of an event) for performing “beacon detection functions”, the geolocation can be a fixed value (determined by any suitable means) for all beacon location data produced by the device.

At 306, the method 300 can include assessing whether the beacon distance between the mobile device and the beacon is sufficiently small, close, or short, according to any suitable criteria. The closer the beacon is to the mobile device, according to the beacon distance, the better a proxy or surrogate the geolocation of the mobile device can be for the geolocation of the beacon. If the beacon distance between the mobile device and the beacon is sufficiently small, then the beacon data can be designated or marked at 314 for upload to the server. In some cases, the upload to the server can be performed essentially immediately after a positive determination at that the beacon data is acceptable at 306, 308, 310, and/or 312. In other cases, the beacon data marked at 314 can be stored for later upload to the server, in some cases along with other marked information pertaining to other beacons. If the beacon distance is too great, the method can return to 302 to consider the next set of beacon data. In some cases, a set of beacon data earlier deemed at 306 not to have a sufficiently small beacon distance for upload could later be marked for upload to the server after it is determined to be the best available data—for example, after a predetermined period has elapsed without further beacon discoveries of the same beacon, after a predetermined time while the beacon is still being detected, or if the mobile computing device has moved a sufficiently far distance from the original beacon discovery location. In some cases, if beacon distance and geolocation information for a beacon discovery are of sufficiently high quality, the beacon data could be uploaded to the server even if not all beacon data of the same beacon have been considered by the filtering method 300. In some cases, beacon data can be uploaded to the server essentially immediately as soon as method 300 determines that the beacon data is of higher quality than previous beacon data for the same beacon. In all cases, uploaded beacon data can include, without limitation: beacon ID, beacon distance, and geolocation.

Filtering beacon data at a beacon-detecting computing device, by the repeated application of method 300 of FIG. 3, or by any other suitable method, can be a process for essentially deriving the best available beacon data from multiple beacon discovery events of an individual beacon by the computing device. Filtering data can benefit system performance by reducing storage of lower quality beacon data and by reducing usage of resources such as wireless data bandwidth and battery power needed to transmit beacon data to the server system.

In some embodiments, processing or filtering of beacon data for a plurality of beacon discoveries of the same beacon can essentially include selecting the shortest beacon distance of the plurality of discoveries, and selecting the highest quality geolocation information of the plurality of discoveries.

In some embodiments, processing or filtering of beacon data for a plurality of beacon discoveries of the same beacon can essentially include combining the beacon distance and the computing device's geolocation information for each individual beacon discovery to arrive at an overall beacon position uncertainty for each individual beacon discovery, then selecting the individual beacon data record with the lowest beacon position uncertainty.

### Server System

Server system 20 can include any suitable computing system(s) and/or resources(s) capable of performing the processing, storage, and communication operations described herein. Server system 20 can include one or more tangible and/or virtual processors, executing one or more operating system environments. Server system 20 can be cloud-based. Server system 20 can be communicatively coupled via any suitable data network(s) with computing devices 14a-14e, and/or information platforms 22, 24, 26, 28, and/or any other suitable device(s).

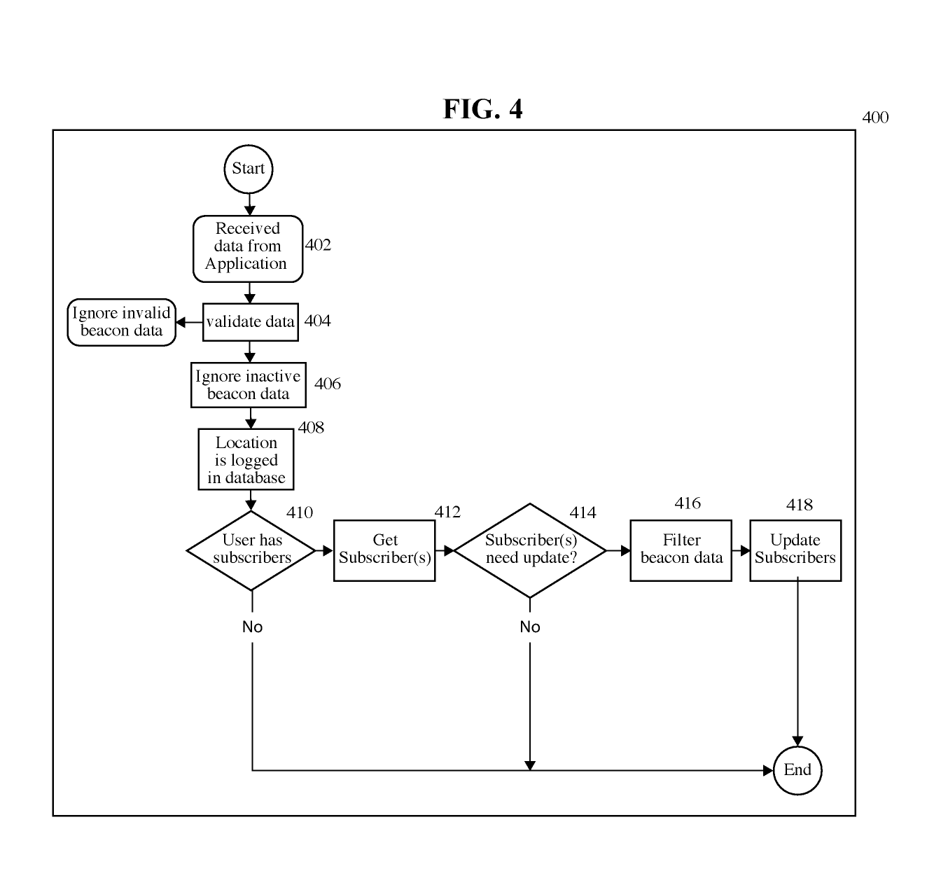

The server system generally can receive beacon data relating to one or more beacons (each with one or more unique beacon IDs), from one or more computing devices 14a-14e, etc. FIG. 4 is a flow diagram of a method 400 for handling beacon data pertaining to a beacon ID that is uploaded to the server. While a particular sequence of operations may be described, suggested, or implied by FIG. 4, such a sequence should not be considered limiting and any suitable sequence of operations is possible unless otherwise explicitly stated. Method 400 can be executed independently for each unique beacon ID for which the server receives uploaded beacon data.

At 402, method 400 can include entering, loading, or otherwise considering beacon data for a beacon ID. At 404, the method can include assessing whether the beacon data is valid, according to any suitable criteria. Such criteria can include, beacon ID validity, geofencing and/or time-fencing. If the data is invalid, method 400 can terminate (for the particular beacon ID for which it is executing). If the data is valid, method 400 can proceed to 406 where the server can determine whether the beacon ID corresponds to an active beacon, and if not, method 400 can terminate. If the beacon (beacon ID) is active, the beacon data can be added to a beacon data database at 408.

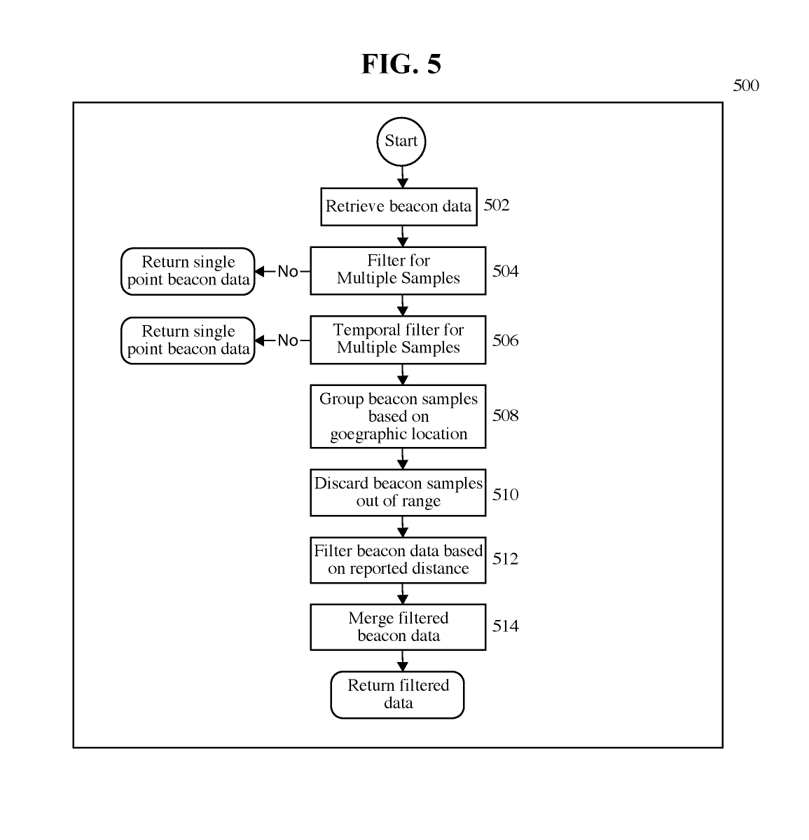

At 410, the server can determine whether there are any subscribers to the beacon, such as user accounts of the beacon tracking system that are indicated for being updated on the beacon's location, or any other valid party or entity indicated to receive beacon data. If not, method 400 can terminate, with beacon data having been added to the database. If there are subscribers, the server can collect, retrieve, or compile a list of subscriber(s) to the beacon at 412. At 414, the server can determine whether the subscriber(s) need or desire an update on the beacon data. For example, if none of the subscribers to the beacon are active (e.g,. no mobile App, web session, etc., is active), then no updates on the beacon data are needed and the method can terminate. If any subscribers do need an update, then method 400 can include performing server filtering of beacon data at 416 (as further discussed elsewhere herein, including in relation to FIG. 5), then updating subscribers with beacon location information at 418. In some embodiments, the method of updating subscribed users can be push notification, e-mail or SMS text messaging. In some embodiments, method 400 can include performing server filtering of beacon data at 416 and the filtered data stored, even if it is determined at 414 that no subscribers need an update on the beacon location. In some embodiments, this filtering can be triggered based on a schedule, at a particular frequency, based on server resource availability or upon request from the user's application or some other criteria. This can prevent processing delays at a subsequent time when a subscriber does require/request an update on a beacon, as the server-filtered beacon data can be retrieved from memory without requiring filtering before being served to the subscriber.

Server 20 can receive beacon data for a particular beacon from multiple computing devices 14a-14e. Filtering such beacon data at 416 by server 20 can be a method for arriving at improved or “best” beacon data for a particular beacon, in terms of the accuracy of location data for the beacon. FIG. 5 is a flow diagram of a method 500 for processing or filtering beacon data at server 20. While a particular sequence of operations may be described, suggested, or implied by FIG. 5, such a sequence should not be considered limiting and any suitable sequence of operations is possible unless otherwise explicitly stated. At 502, method 500 can include retrieving, loading, or otherwise considering beacon data for a beacon ID being filtered. The retrieved beacon data can include all beacon data for the beacon ID being filtered, or it can be any suitable subset of such data. In some examples, the beacon data can be pre-filtered by any suitable criteria before entering the filtering method of method 500. At 504, if there is only one set or sample of beacon data (from a single discovery), then that single set of beacon data can be returned by filter method 500 and the filtering can terminate. If there are multiple samples, the method can proceed to 506, where the temporal proximity of the samples can be considered. If a predetermined criteria for scarcity of samples is satisfied (e.g., there is only one sample in the past four minutes), then all samples can be returned to the database for potential dissemination to subscribers.

If there are multiple samples within a predetermined time interval, method 500 can proceed to further filtering at 508, where beacon samples can be grouped by location, according to any suitable predetermined criteria for geographic proximity. At 510, for each geographic grouping, beacon data that fall outside a predetermined temporal range can be discarded.

At 512, method 500 can include filtering beacon data by beacon distance, with smaller distances being favored. At 514, method 500 can include filtering beacon data by geolocation quality/accuracy. At 514, based in part upon filter at 512, beacon data can be combined into a single point representing the best aggregate information about the position of the particular beacon. While operations 508, 510, 512, and 514 are graphically represented as distinct operations in FIG. 5, this is not limiting and in some embodiments these can be integrated operations.

At 508, 510, 512, 514, filtering and combining can be performed according to any suitable criteria. In some embodiments, criteria can be dynamic based upon data availability, with more stringent criteria being applied when more data are available or can be weighted to give preference to a particular criteria.

In some embodiments, filtering and combining at 508, 510, 512, 514 can essentially include combining the beacon distance and the computing device geolocation information for each individual sample to arrive at an overall beacon position uncertainty for each individual sample, then selecting the individual sample with the lowest beacon position uncertainty.

At 514, method 500 can include storing the filtered location data for a beacon in a beacon position database. An entry in the beacon position database can include beacon ID, beacon location, and time at the beacon location.

### Providing Beacon Data

Systems and methods of the present disclosure can provide near-real time information about the location of tracked beacons 12a-12d to users of the system as well as other data associated with the beacon at the location(s) where it was detected. Beacon data can be provided via “beacon location reporting” functions of the App running on a mobile computing device 14a-14e as well as via other information platforms 22, 24, 26 and 28, which can include, for example, an event website. As described elsewhere herein, a user may be required to register as a user of the beacon tracking system and provide information such as identities of mobile-points-of-interest whose locations are of interest to the user and identifying information about specific events of interest to the user.

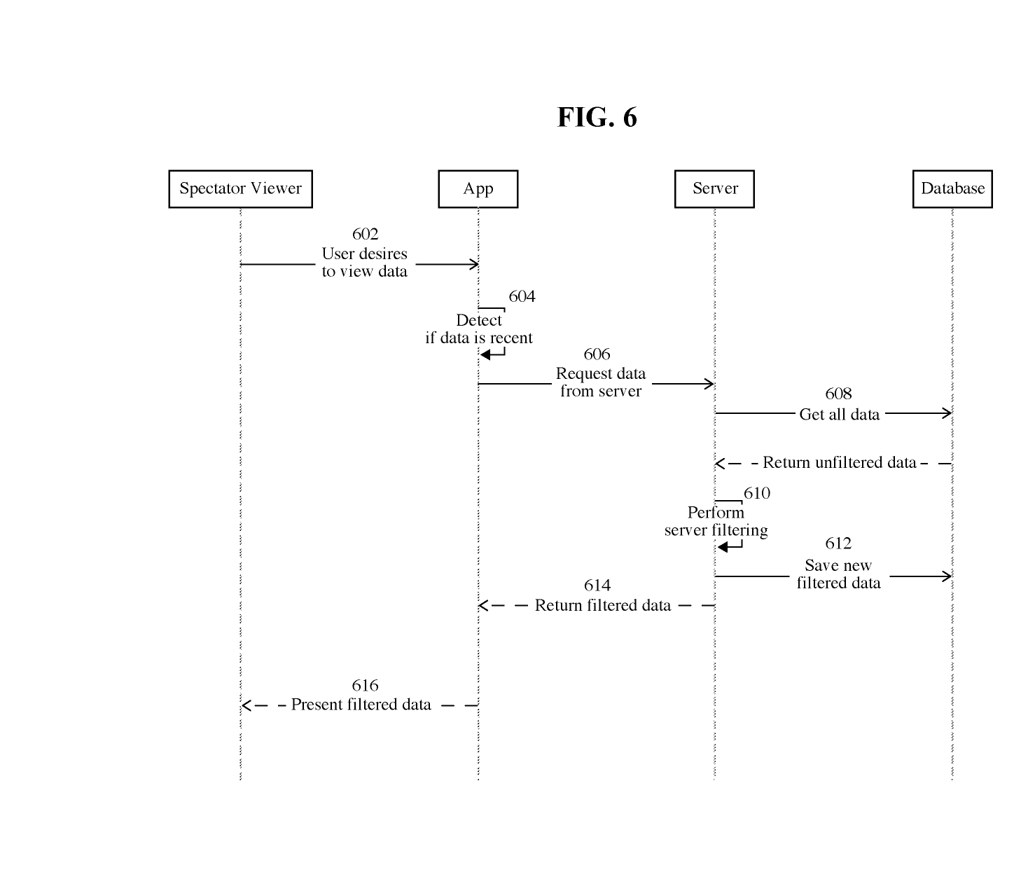

FIG. 6 is a flow diagram that illustrates aspects of the beacon tracking system of the present disclosure particularly relating to reporting of beacon location information. At 602, a user can indicate their desire to view beacon data for a beacon ID, in any appropriate manner. For example, the user may interact with a user interface of an App on a mobile device to specifically indicate their interest in a particular mobile point of interest, or they may more passively indicate their interest by launching the (previously idle) App or requesting that the App refresh location information. At 604, the App can assess the freshness of beacon data held in its memory, and if the data is not recent according to a predetermined threshold, the mobile device App can request beacon data from the server at 606. At 608, the server can retrieve beacon data from its database. If the data has not already been filtered, the server can filter the data at 610 (for example, in accordance with method 500 of FIG. 5), then save the newly filtered data to the database at 612. At 614, the server can transmit filtered beacon data to the App, and the App can display the filtered beacon data at 616. In some cases, the server can transmit filtered beacon data to other users' Apps even if they have not actively requested beacon data, using a push notification or any other suitable communication protocol.

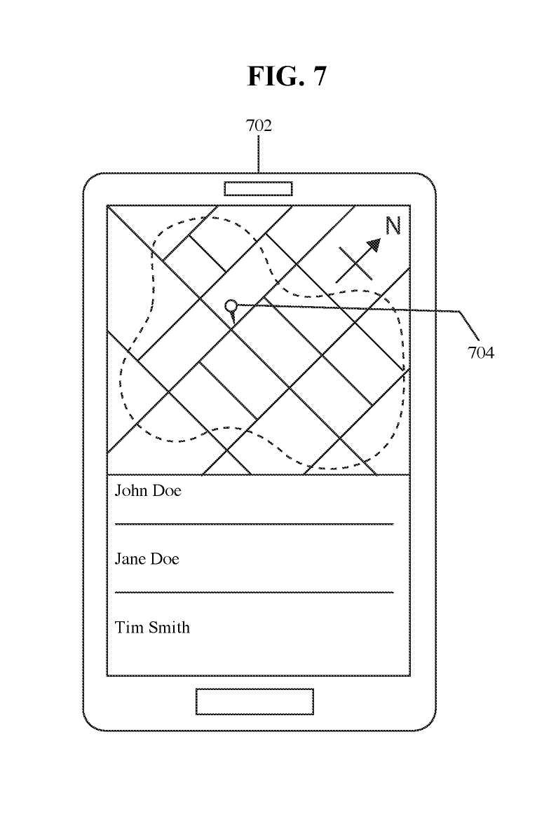

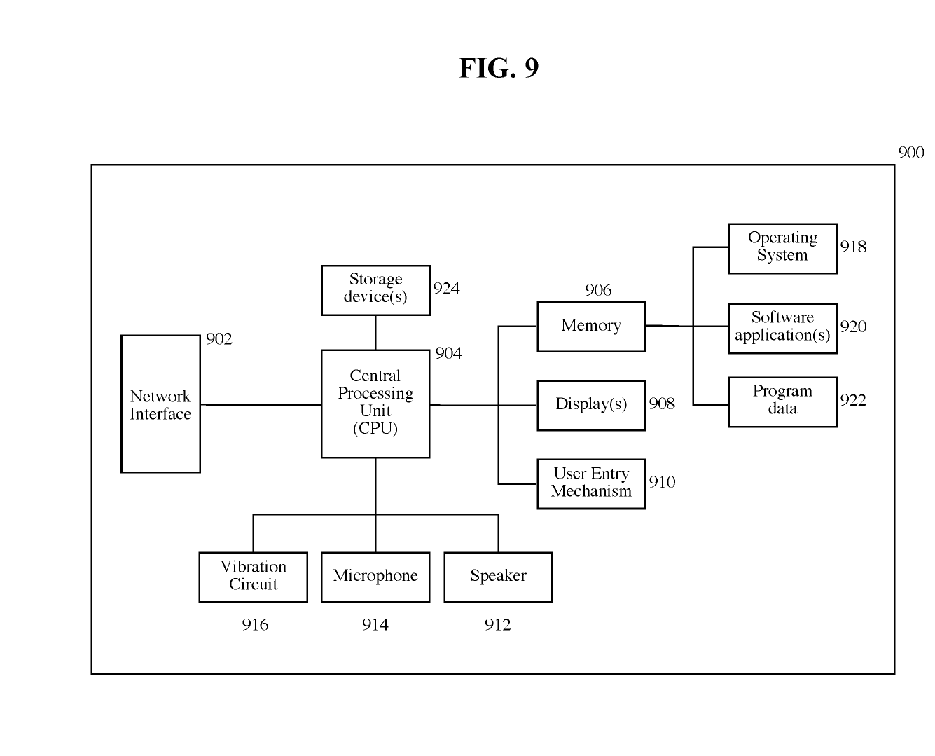

Beacon data can be presented in any suitable manner. On a mobile device, for example, the App can present a user/spectator with a home screen that illustrates a map of the user's surrounding geographical region. If there are race participants or other mobile points of interest with active beacons in the surrounding geographical region, the mobile application can direct the mobile device to scan for and display the nearby beacons. The mobile application can then display to the spectator a map with corresponding beacons and beacon events, as illustrated in FIG. 7. 702 is an example of a computing device, such as computing device 900 of FIG. 9 that can include a display 908, that performs “Beacon Location Reporting” where the representation of beacon location data is depicted in 704. At 704, the application is presenting a geographical location, but is not limited to only displaying one data point. Beacon data can include, but are not limited to, beacon identity, geographic coordinates of the beacon, geolocation accuracy, and beacon signal strength. In some embodiments, the spectator may configure the map to only display beacon events for mobile points of interest (i.e., beacons) that the spectator has chosen to view and pre-programmed into the mobile application. In other embodiments, the map may display all beacons and related beacon events associated with the race.

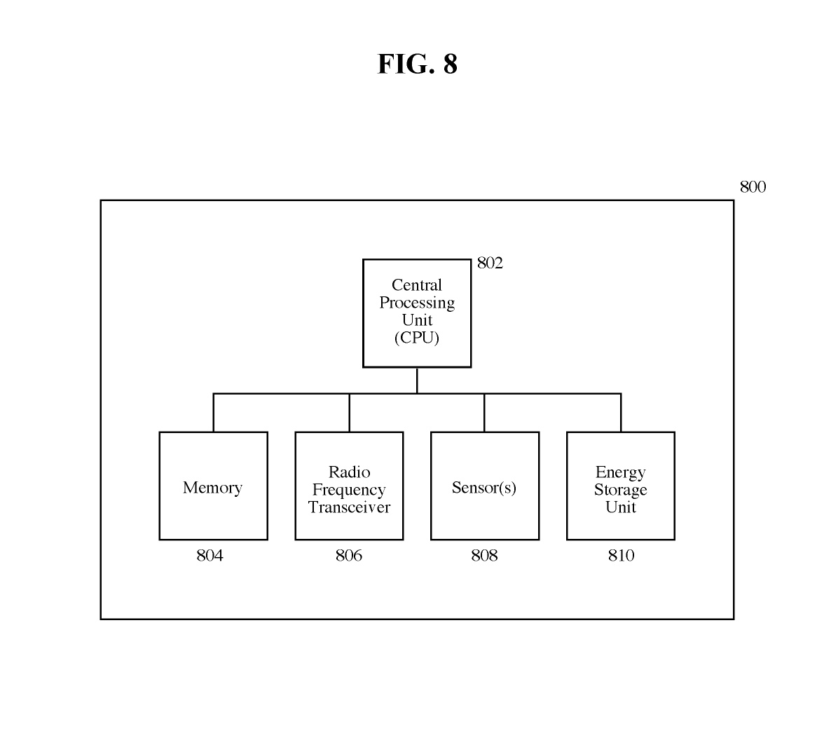

Illustrated in FIG. 8 is an example radio frequency transmitter device which could transmit a beacon signal. Is to be understood that the system can include one or more radio frequency transmitter devices but only one is depicted here for readability and simplicity. In some examples, the radio frequency transmitter devices 800 includes at least one processor or processing unit 802 and system memory 804. The processor 802 can be a device configured to process a set of instructions. In some embodiments, system memory 804 can be a component of processor 802; in other embodiments system memory 804 can be separate from the processor 802. Depending on the exact configuration and type of computing device, the system memory 804 may be volatile (such as RAM), non-volatile (such as ROM, flash memory, etc.) or some combination of the two.

The radio frequency transmitter device can have one or more radio frequency transmitter and/or receivers which can be combined into one unit (“transceivers”) 806. The radio frequency transceiver 806 can receive instructions from the processer 802 to transmit or receive a radio signal.

In some embodiments, the radio frequency transmitter device 800 can have additional features or functionality. For example, the radio frequency transmitter device 800 can also include additional sensor devices 808 such as, for example, accelerometers, magnetometers, altimeters or gyroscopes.

The radio frequency transmitter device can receive power from any type of energy storage or harvesting unit 810. This can include but is not limited to battery power, mechanical harvesting, solar harvesting or alternating current from an exterior source. The energy storage unit 810 connects to the remainder of the radio frequency transmitter device 800 and can provide enough power for the radio frequency transmitter device 800 to execute its functions.

In some embodiments, the system described herein uses a computing system to carry out the various functions described herein. Is to be understood that the system can include one or more computing systems but only one is depicted here for readability and simplicity. FIG. 9 is a schematic block diagram of an example computing system 900. In some embodiments, the computing system 900 further includes a communication network 902 and one or more additional computing devices 900 (such as a server).

The computing device 900 can be a computing device 900 located in a user's home or other place of business. In some embodiments, computing device 900 is a mobile device. The computing device 900 can be a stand-alone computing device or a networked computing device that communicates with one or more other computing devices 900 across a network 902. The additional computing device(s) 900 can be, for example, located remotely from the first computing device 900, but configured for data communication with the first computing device 900 across a network 902.

In some examples, the computing devices 900 include at least one processor or processing unit 904 and system memory 906. The processor 904 is a device configured to process a set of instructions. In some embodiments, system memory 906 may be a component of processor 904; in other embodiments system memory 906 is separate from the processor 904. Depending on the exact configuration and type of computing device, the system memory 906 may be volatile (such as RAM), non-volatile (such as ROM, flash memory, etc.) or some combination of the two. System memory 906 typically includes an operating system 918 suitable for controlling the operation of the computing device 900, such as the WINDOWS® operating systems or the OS X operating system, or a server, such as Windows SharePoint Server, also from Microsoft Corporation, or such as a Mac running OS X. The system memory 906 may also include one or more software applications 920 and may include program data 922.

The computing device 900 may have additional features or functionality. For example, the computing device 900 may also include additional data storage devices 924 (removable and/or non-removable) such as, for example, magnetic disks, optical disks, or tape. Computer storage media 924 may include volatile and nonvolatile, removable and non-removable media implemented in any method or technology for storage of information, such as computer readable instructions, data structures, program modules, or other data. System memory, removable storage, and non-removable storage are all examples of computer storage media. Computer storage media 924 includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device 900. An example of computer storage media 924 is non-transitory media.

In some examples, one or more of the computing devices 900 can be located in an establishment. In other examples, the computing device 900 can be a personal computing device that is networked to allow the user to access and utilize the system disclosed herein from a remote location, such as in a user's home, office or other location. In some embodiments, the computing device 900 is a smart phone tablet, laptop computer, personal digital assistant, or other mobile device. In some embodiments, system operations and functions are stored as data instructions for a smart phone application. A network 902 facilitates communication between the computing device 900 and one or more servers, such as an additional computing device 900, that hosts the system. The network 902 may be a wide variety of different types of electronic communication networks. For example, the network 902 may be a wide-area network, such as the Internet, a local-area network, a metropolitan-area network, or another type of electronic communication network. The network 902 may include wired and/or wireless data links. A variety of communications protocols may be used in the network 902 including, but not limited to, Wi-Fi, Ethernet, Transport Control Protocol (TCP), Internet Protocol (IP), Hypertext Transfer Protocol (HTTP), SOAP, remote procedure call protocols, and/or other types of communications protocols.

In some examples, the additional computing device 900 is a Web server. In this example, the first computing device 900 includes a Web browser that communicates with the Web server to request and retrieve data. The data is then displayed to the user, such as by using a Web browser software application. In some embodiments, the various operations, methods, and functions disclosed herein are implemented by instructions stored in memory. When the instructions are executed by the processor 904 of the one or more computing devices 900, the instructions cause the processor 904 to perform one or more of the operations or methods disclosed herein.

Persons of ordinary skill in arts relevant to this disclosure and subject matter hereof will recognize that embodiments may comprise fewer features than illustrated in any individual embodiment described by example or otherwise contemplated herein. Embodiments described herein are not meant to be an exhaustive presentation of ways in which various features may be combined and/or arranged. Accordingly, the embodiments are not mutually exclusive combinations of features; rather, embodiments can comprise a combination of different individual features selected from different individual embodiments, as understood by persons of ordinary skill in the relevant arts. Moreover, elements described with respect to one embodiment can be implemented in other embodiments even when not described in such embodiments unless otherwise noted. Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended. Furthermore, it is intended also to include features of a claim in any other independent claim even if this claim is not directly made dependent to the independent claim.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of Section 112, sixth paragraph of 35 U.S.C. are not to be invoked unless the specific terms “means for” or “step for” are recited in a claim.

What is claimed is:

1. A system for tracking mobile points of interest within a geographical region, the system comprising:
one or more beacons affixed to one or more corresponding mobile points of interest, wherein each of the one or more beacons is structured and configured to broadcast advertisements with unique identifying information via a short-range communication protocol;
one or more mobile computing devices, each mobile computing device including:
beacon communication hardware configured to receive advertisements broadcast by the one or more beacons;
Internet communication hardware; and
geolocation capability,
wherein each mobile computing device is programmed and configured to:
record received advertisements from the one or more beacons along with corresponding geolocation information from the geolocation capability;
for each of the one or more beacons from which the mobile computing device has recorded received advertisements, filter the recorded received advertisements along with corresponding geolocation information, to result in device-filtered beacon location data; and
transmit the device-filtered beacon location data via the Internet communication hardware; and
an Internet-connected server, wherein the server is programmed and configured to:
receive and record the device-filtered beacon location data from each of the one or more mobile computing devices for each of the one or more beacons from which the one or more mobile computing devices have recorded received advertisements;
for each of the one or more beacons from which the one or more mobile computing devices have recorded received advertisements, filter the device-filtered beacon location data, to result in server-filtered beacon location data; and
transmit the server-filtered beacon location data to at least one other entity.
